(19) United States
(12) Patent Application Publication
(10) Pub. No.: US 2018/0245002 A1
(43) Pub. Date: Aug. 30, 2018

(54) Methods, Systems, and Apparatuses for Use of Carbon Dioxide in a Fischer-Tropsch System

(71) Applicant: SGC Energia Co LLC, Pasadena, TX (US)

(72) Inventors: Juan Ricardo Inga, Pasadena, TX (US); Leo Bonnell, Beverly, TX (US)

(21) Appl. No.: 15/577,520

(22) PCT Filed: May 31, 2016
(86) PCT No.: PCT/IB2016/000830

§ 371 Date: Nov. 28, 2017

Related U.S. Application Data
(60) Provisional application No. 62/168,743, filed on May 30, 2015.

(51) Int. Cl. C10G 2/00; C01B 3/36; C01B 3/34

(52) U.S. Cl. CPC C10G 2/332; C10G 2/341; C10G 2/50; C01B 3/36; C01B 2203/1258; C01B 2203/025; C01B 2203/0205; C01B 2203/062; C01B 2203/1241; C01B 3/34

(57) ABSTRACT

The present disclosure includes a method of producing a liquid FT hydrocarbon stream, an FT tail gas stream and an FT water stream using an FT reactor feed in an FT reactor under low temperature, high pressure FT operating conditions. The FT reactor feed includes syngas, the syngas having a low H₂:CO ratio in the range of approximately 1.4:1 to approximately 1.8:1, and carbon dioxide at a level of at least as high as about 10 volume percent. The FT reactor has a cobalt-based, alumina-supported FT catalyst. In embodiments, a syngas preparation unit is used to produce the syngas and carbon dioxide recovered from the FT tail gas is recycled to the syngas preparation unit. Other methods, systems and apparatuses are also disclosed.

### STATEMENT REGARDING FEDERALLY SPONSORED RESEARCH OR DEVELOPMENT

Not applicable.

### BACKGROUND

### Field of the Invention

The present invention relates to a system and method for Fischer-Tropsch gas to liquid hydrocarbon production. Specifically, the present invention relates to a system and method for using carbon dioxide in a Fischer-Tropsch system.

### Background of the Invention

The Fischer-Tropsch (or “Fischer Tropsch” or “FT”) process (or synthesis) involves a set of chemical reactions that convert a mixture of carbon monoxide and hydrogen (known as reformed gas or synthesis gas, or ‘syngas’) into liquid hydrocarbons. The FT process was first developed by German chemists Franz Fischer and Hans Tropsch in the 1920's. The FT conversion is a catalytic and exothermic process. The FT process is utilized to produce petroleum substitutes, typically from carbon-containing energy sources such as coal, natural gas, biomass, or carbonaceous waste streams (such as municipal solid waste) that are suitable for use as synthetic fuels, waxes and/or lubrication oils. The carbon-containing energy source is first converted into a reformed gas (or synthetic gas or syngas), using a syngas preparation unit in what may be called a syngas conversion. Depending on the physical form of the carbon-containing energy source, syngas preparation may involve technologies such as steam methane reforming, gasification, carbon monoxide shift conversion, acid gas removal gas cleaning and conditioning. These steps convert the carbon source to simple molecules, predominantly carbon monoxide and hydrogen, which are the active ingredients of synthesis gas but inevitably also containing carbon dioxide, water vapor, methane, nitrogen. Impurities deleterious to catalyst operation such as sulfur and nitrogen compounds are often present in significant or trace amounts and are removed to very low concentrations as part of synthesis gas conditioning.

Turning to the syngas production step, to create the syngas from natural gas, for example, methane in the natural gas reacts with steam and/or oxygen in a syngas preparation unit to create syngas. This syngas comprises principally carbon monoxide, hydrogen, carbon dioxide, water vapor and unconverted methane. When partial oxidation is used to produce the synthesis gas, typically it contains more carbon monoxide and less hydrogen than is optimal and consequently, the steam is added to the react with some of the carbon monoxide in a water-gas shift reaction. The water gas shift reaction can be described as:

CO+H₂O⇄H₂+CO₂ (1)

Thermodynamically, there is an equilibrium between the forward and the backward reactions. That equilibrium is determined by the concentration of the gases present and temperature.

Once the syngas is created and conditioned, the syngas is used as an input to an FT reactor having an FT catalyst to make the liquid FT hydrocarbons in a Fischer-Tropsch synthesis (or FT synthesis or FT conversion). Depending on the type of FT reactor, the FT conversion of the syngas to liquid FT hydrocarbons takes place under appropriate operating conditions. The Fischer-Tropsch (FT) reactions may be simplistically expressed as:

(2n+1)H₂+n CO→CₙH₂ₙ₊₂+n H₂O, (2)

where ‘n’ is a positive integer, preferably greater than 1.

As mentioned above, the FT reaction is performed in the presence of a catalyst, called a Fischer-Tropsch catalyst (“FT catalyst”). Unlike a reagent, a catalyst accelerates the chemical reaction and is not consumed by the reaction itself. In addition, a catalyst may participate in multiple chemical transformations. The activity level of an FT catalyst may decrease over time with use.

In addition to liquid hydrocarbons, Fischer-Tropsch synthesis also commonly produces gases (“Fischer-Tropsch tail gases” or “FT tail gases”) and water (“FT water”). The FT tail gases typically contain CO (carbon monoxide), CO₂ (carbon dioxide), H₂ (hydrogen), light hydrocarbon molecules, both saturated and unsaturated, typically ranging from C₁ to C₄, and a small amount of light oxygenated hydrocarbon molecules such as methanol. Typically, FT tail gases are mixed in a facility's fuel gas system for use as fuel. The FT water may contain contaminants, such as dissolved hydrocarbons, oxygenates (alcohols, ketones, aldehydes and carboxylic acids) and other organic FT products. Typically, FT water is treated in various ways to remove the contaminants and is properly disposed of.

Carbon dioxide emissions from use of fossil fuels are becoming increasingly problematic. The lifetime of carbon dioxide as a pollutant is poorly defined because the gas is may move among different parts of the ocean-atmosphere-land system. Some of the excess carbon dioxide will be absorbed quickly (e.g. by the ocean surface, forests, etc.), but some will remain in the atmosphere for thousands of years, due in part to the very slow process by which carbon is transferred to ocean sediments. As carbon dioxide is a component of FT tail gas, some operators recover the carbon dioxide from the FT tail gas for sequestration or other disposal.

Many Fischer Tropsch catalysts have been tested since 1920's. What is commonly understood is that iron-based FT catalysts have water gas shift properties, while cobalt-based FT catalysts do not. These conclusions were made under conditions involving using syngas having low H₂/CO ratios in a Fischer Tropsch reactor using either an iron-based FT catalyst or a cobalt-based FT catalyst. By a “low H₂/CO ratio,” a ratio lower than the approximately 2:1 stoichiometric ratio of a Fischer Tropsch reaction is meant. A ratio of 2.15:1 is typical. See also, for example, “Comparative study of Fischer-Tropsch synthesis with H₂/CO and H₂/CO₂ syngas using Fe- and Co-based catalysts,” T. Riedel, M. Claeys, H. Schulz, G. Schaub, S. Nam, K. Jun, M. Choi, G. Kishan, K. Lee, in APPLIED CATALYSTS A: GENERAL 186 (1999), pp. 201-213 (“Riedel et al.”), which at page 212 concluded, “Fischer-Tropsch CO₂ hydrogenation would be possible even in a commercial process with iron, however, not with cobalt catalysts.”

Consideration of the H₂/CO ratio that will be present in the syngas is important when selecting the combination of syngas production technology (i.e. how the syngas is created, also called the “reforming process”) and the Fischer Tropsch synthesis technology (i.e. how the syngas is used in an FT reactor with an FT catalyst to create the liquid hydrocarbons). For example, using coal to produce the syngas results in a syngas having a relatively low H₂/CO ratio. With a syngas having a relatively low H₂/CO ratio, operators have typically selected an iron-based catalyst for the Fischer Tropsch catalyst because iron has a strong water-gas shift activity. The strong water-gas shift activity promotes the production of additional hydrogen for use in the FT reaction. In effect, the selection of an iron-based FT catalyst to be used with syngas from coal balances the relatively low H₂/CO ratio in the syngas. Thus, many iron-based catalysts are able to reach thermodynamic equilibrium while performing as a Fischer Tropsch catalyst. This is not the case of cobalt-based FT catalysts, which have been considered to have a very low water gas shift activity. Most of the reported cobalt-based FT catalysts have less than 1% CO₂ selectivity.

A syngas feed for an FT process typically contains less than 1.62 volume % carbon dioxide. See, for example, K. A. Petersen, T. S. Christensen, I. Dybkjaer, J. Sehested, M. Ostberg, R. M. Coertzen, M. J. Keyser, A. P. Steynberg., Chapter 4, “Synthesis Gas Production for FT Synthesis,” in FISCHER TROPSCH TECHNOLOGY, STUDIES IN SURFACE SCIENCE AND CATALYSIS 152, p. 261 (TABLE 1) (A. P. STEYNBERG, M. E. DRY ed., December 2004).

For many years, CO₂ has been considered either to be inert or detrimental to cobalt-based FT catalysts. See, for example, “Development of a CO₂ Tolerant Fischer Tropsch Catalyst: From Laboratory to Commercial Scale Demonstration in Alaska”, J. J. H. M. Font Freide, T. D. Gamlin, J. R. Hensman, B. Nay, C. Sharp, Journal of Natural Gas Chemistry 13 (2004), pp 1-9. When testing 100% CO₂ hydrogenation for very low concentrations of CO₂ (<6.1%), researchers have found that some portion of the CO₂ that reaches the FT reactor actually helps make the liquid hydrocarbons. However, those researchers concluded that CO₂ hydrogenation to Fischer Tropsch products was not a commercial alternative. See “CO and CO₂ Hydrogenation Study on Supported Cobalt Fischer Tropsch Synthesis Catalyst,” Y. Zhang, G. Jacobs, D. Sparks, M. E. Dry, B. H. Davis, Catalysis Today 71, (2002), pp. 411-418.

U.S. Pat. No. 8,168,684 to Hildebrandt, et al. (the “Hildebrandt patent”), incorporated in its entirety herein by reference for purposes not contrary to this disclosure, discloses a Fischer Tropsch process with a “CO₂ rich syngas.” The Hildebrandt patent defines a “CO₂ rich syngas” as “a gas mixture in which there is CO₂, H₂ and CO. The CO₂ composition in this mixture is in excess of the CO₂ which would usually occur in conventional syngas.” (Column 2, lines 17-20.) The example described therein used coal as a feedstock. (See the Hildebrandt patent at Col. 4, line 32 “The feed considered was coal.”) The patent also mentions the use of feedstocks comprising methane from natural gas (the Hildebrandt patent at Col. 3, lines 36-40 and Col. 5, lines 23-25) and gas “generated by fermentation of natural waste dumps” (the Hildebrandt patent at Col. 5, lines 23-25). The Hildebrandt patent at Col. 2, lines 20-21 states: “The CO₂ is utilized as a reactant and is converted into the desired product.” The Hildebrandt patent also notes, “Unreacted carbon dioxide, carbon monoxide and hydrogen may be recirculated from the Fischer Tropsch synthesis section (5) into the gasifier/reforming process stage (3) via a conduit (7) or back to the Fischer Tropsch synthesis section.” (The Hildebrandt patent at Col. 3, lines 28-31.)

Claim 1 of the Hildebrandt patent recites in part the production of “hydrocarbons according to the overall process mass balance:

CO₂+3H₂⇄CH₂+2H₂O,″ (3)

an reaction which is known to work with iron-based FT catalysts, but not known to work with cobalt-based FT catalysts. (See Riedel et al, which at page 212 concluded, “Fischer-Tropsch CO₂ hydrogenation would be possible even in a commercial process with iron, however, not with cobalt catalysts.”) The Hildebrandt patent does not, however, disclose the FT catalyst or the type of FT catalyst used in the FT process(es) described.

U.S. Pat. No. 8,461,219 to Steiner et al. (the Steiner Patent) discloses preparation of synthesis gas used as an input to an FT process with the “introduction of carbon dioxide recirculated from” the output of the FT reactor “into the synthesis gas during or after the preparation of synthesis gas,” wherein the synthesis gas used as an input to the FT reactor has “a hydrogen to carbon ratio of [less than or equal to] 1.2:1.” (The Steiner Patent at Col. 2, lines 12-30.) The specified H₂:CO ratio of 1.2:1 may be considered quite low. While the Steiner Patent asserts that “iron- or cobalt-comprising heterogeneous catalyst can preferably be used in step c) [the FT conversion step],” (the Steiner Patent at Col. 3, lines 8-10), the Steiner Patent further states, “A Fischer-Tropsch catalyst which is a carbonyl iron powder catalyst having spherical primary particles is particularly preferred in step c).” (The Steiner Patent at Col. 3, lines 11-13.) It appears that such an iron-based catalyst was used in each of the examples described in the Steiner Patent: (1) for Example 1, “a carbonyl iron powder catalyst having spherical primary particles was produced . . . ” (the Steiner Patent at Col. 4, lines 64-Col. 5, line 1) and used with synthesis gas mixture having a H₂ to CO ratio of 1:1; (2) for Example 2, the “trial was carried out by a method analogous to example 1, with the ratio of hydrogen to carbon monoxide in the synthesis gas being 0.9:1” (the Steiner Patent at Col. 5, lines 17-19); and (3) for Example 3, a “Comparative Example” which was conducted at a much higher H₂:CO ratio, outside of that recited in the claims, the “process was operated under reaction conditions analogous to example 1, with the ratio of hydrogen to carbon monoxide in the synthesis gas being set to 2:1” (the Steiner Patent at Col. 5, lines 33-35).

A publication entitled, “Effect of Recycle Gas on Activity and Selectivity of CO—Ru/Al₂O₃ Catalyst in Fischer-Tropsch Synthesis,” A. A. Rohani, B. Hatami, L. Jokar, F. Khorasheh, A. A. Safekordi, World Academy of Science, Engineering and Technology, Vol. 3, Jan. 21, 2009 (pp. 549-553) (“Rohani, et al.”) reports experiments in carbon dioxide recycling in an FT system with cobalt FT catalysts with combination ruthenium and lanthanum promoters on an Al₂O₃ support. Rohani et al., conducted experiments using the Co—Ru—La catalysts in a micro reactor with a fixed bed column and a ratio of H₂ to CO of 2. (Rohani et al., page 550, left column). Reactions were performed at three temperatures and at atmospheric pressure. Ibid.

Rohani et al., disclose that while adding “small amounts of CO₂ to the feed stream did not change the CO conversion significantly,” with an “injection of about 10 vol. % and more [of CO₂ in the feed], however, the CO conversion would decrease.” (Rohani et al., page 551, right column). The reduction in CO conversion was more significant at lower temperatures. (Rohani et al., page 552, left column). Similarly, “adding small amounts of CO₂ (less than 10 vol. %) would not significantly affect the product selectivity. Further increases in the amount of CO₂ in the feed, however, would decrease the selectivity for CH₄ and other volatile hydrocarbons and increase those for the heavy components (C₅+).” (Rohani et al., page 552, left column). “If there was no CO₂ in the feed, the relative activity of the catalyst would decrease 21.8% in the first 15 hours but with 20% CO₂ in the feed, the reduction of the relative activity was 39.8% over the same time period. The reduction of activity was only significant in the first 15 hours.” (Rohani et al., page 553, bottom of left column to top of right column).

Many operators use a cleaning step for the syngas to reduce the level of carbon dioxide. For example, some use a costly acid gas removal process, in which both CO₂ and H₂5 are removed. The H₂S is considered a poison for the FT catalyst, while the CO₂ is considered inert; simultaneous removal has been commonly practiced. When natural gas is the feedstock used to create the syngas, the removal of sulfur and sulfur compounds can be done prior to the reforming step. If natural gas is the feedstock and if the sulfur and sulfur compounds are removed prior to reforming the natural gas into syngas, an acid gas cleaning step performed after the reforming would be solely for the removal of CO₂.

Accordingly, there are needs in the art for novel systems and methods for using a syngas containing higher levels of carbon dioxide than are normally recommended in an FT process, to avoid the costs involved in reducing the carbon dioxide down to the recommended levels. Desirably, such systems and methods would enable an recycling as much of the carbon dioxide in the process as possible. Desirably, such systems and methods would have no deleterious effects on the FT process and in one or more embodiment would improve performance of the FT reactor.

### SUMMARY

These and other embodiments, features and advantages will be apparent in the following detailed description and drawings.

The present disclosure includes a method of producing Fischer-Tropsch (“FT”) hydrocarbons via FT synthesis in an FT reactor. The method includes producing a liquid FT hydrocarbon stream, an FT tail gas stream and an FT water stream using an FT reactor feed in the FT reactor under low temperature, high pressure FT operating conditions using a cobalt-based, alumina-supported FT catalyst. The FT reactor feed includes a mixture of carbon dioxide and syngas, the syngas having a low H₂:CO ratio in the range of approximately 1.4:1 to approximately 1.8:1, and, the FT reactor feed having a level of carbon dioxide at least as high as about 10 volume percent. The syngas may be produced by a syngas preparation unit. The syngas preparation unit may be a steam methane reformer and the method may include a step of treating the syngas produced by the syngas preparation unit to achieve the low H₂:CO ratio.

The present disclosure includes a system for producing Fischer Tropsch (“FT”) hydrocarbons. The system includes a syngas preparation unit for using a sweet natural gas, a stream of steam and a stream of carbon dioxide gas as inputs to produce a mixture of carbon dioxide and a syngas, the syngas comprising hydrogen and carbon monoxide, having an initial H₂:CO ratio. The system includes a LTHP FT reactor, fluidly connected to the syngas preparation unit. The LTHP FT reactor includes an FT synthesis catalyst comprising a cobalt-based, alumina-supported FT catalyst. The LTHP FT reactor is configured to use a mixture of syngas that has a low H₂:CO ratio ratio in the range of approximately 1.4:1 to approximately 1.8:1, and carbon dioxide as an FT reactor feed to make, under FT operating conditions, liquid FT hydrocarbons. The FT reactor feed has a carbon dioxide level of at least about 10 volume percent. The system may include a carbon dioxide recovery unit to recover a carbon dioxide stream from a portion of the FT tail gas.

The present disclosure includes an apparatus for producing Fischer Tropsch (“FT”) hydrocarbons. The apparatus includes a LTHP FT reactor having an FT synthesis catalyst comprising a cobalt-based, alumina-supported FT catalyst. The LTHP FT reactor is configured to use a FT reactor feed of a conditioned mixture including syngas having a low H2:CO ratio in the range of approximately 1.4:1 to approximately 1.8:1, and carbon dioxide to make, under FT operating conditions liquid FT hydrocarbons, FT tail gas and FT water. The FT reactor feed has a carbon dioxide level of at least about 12 volume percent. Some of the carbon dioxide in the FT reactor feed may be carbon dioxide recovered from the FT tail gas and recycled upstream of the FT reactor.

### BRIEF DESCRIPTION OF THE DRAWINGS

For a more detailed description of the present invention, reference will now be made to the accompanying drawings, wherein:

FIG. 1 depicts a block diagram of a Fischer Tropsch system in accordance with one or more embodiments of the present disclosure, which include recycle of carbon dioxide and of a first portion of an FT tail gas to a syngas preparation unit.

FIG. 2 depicts a simplified flow diagram for a Fischer Tropsch system in accordance with one or more embodiments of the present disclosure, wherein a first portion of an FT tail gas is recycled to a syngas preparation unit, a second portion of the FT tail gas is treated for utilization and carbon dioxide is recycled as a feed to an FT reactor.

FIG. 3 depicts a simplified flow diagram for a Fischer Tropsch system in accordance with one or more embodiments of the present disclosure, wherein a first portion of an FT tail gas is recycled to a syngas preparation unit, a second portion of the FT tail gas and of a FT purge stream are treated for utilization, and carbon dioxide is recycled both as a feed to an FT reactor and as a feed to a syngas preparation unit.

FIG. 4 depicts a flowchart in accordance with one or more embodiments of the present disclosure, wherein carbon dioxide is recycled as a feed to a syngas preparation unit.

### NOTATION AND NOMENCLATURE

As used herein, the abbreviation “FT” and/or “F-T” stand for Fischer Tropsch (which may be written “Fischer-Tropsch”). A Fisher-Tropsch reactor, for example, may also be referred to as a “FT synthesis reactor” or “FT reactor” herein.

As used herein, the term “FT purge stream” means excess FT tail gas removed from the primary FT tail gas stream. The FT purge stream has the same composition as the FT tail gas.

As used herein, the term “FT tail gas” means gas produced from an FT reactor. The FT tail gas may typically contain unreacted hydrogen and carbon monoxide, as well as carbon dioxide, some light hydrocarbons, and other light reaction byproducts.

As used herein, the term “FT water” means water produced by an FT reaction. The water will typically include dissolved oxygenated species, such as alcohols, and light hydrocarbons.

As used herein, the term “liquid FT hydrocarbon products” means liquid hydrocarbons produced by an FT reactor.

As used herein, the phrase a “low H₂/CO ratio” as used herein means a H₂/CO ratio lower than the 2:1 stoichiometric ratio of a Fischer Tropsch reaction. The phrase a “low H₂:CO ratio” as used herein means a H₂/CO ratio higher than 1.2:1, lower than 2:1, preferably in a range of 1.4:1 to approximately 1.8 to 1 and more preferably about 1.6:1.

As used herein, the terms “reformed gas” or “synthesis gas” or “syngas” means the effluent from a syngas preparation unit, such as (without limitation) a steam methane reformer, autothermal reformer, hybrid reformer, or partial oxidation reactor. Steam methane reformers do not use oxygen as part of the process; autothermal reformers do. Both use reformer catalysts. Hybrid reformers are a combination of steam methane reforming, as a first step, and an autothermal reforming with oxidation as a second step. Partial oxidation reactors are similar to autothermal reformers, but do not include the use of a reformer catalyst.

As used herein, the term “sweet natural gas” means natural gas from which any excess sulfur or sulfur compounds such as H₂S has been previously removed.

As used herein, the term “tubular reactor” refers to Fischer-Tropsch reactors containing one or more tubes containing FT catalyst, wherein the inner diameter or average width of the one or more tubes is typically greater than about 0.5 inches. Use of the term “tubular” is not meant to be limiting to a specific cross sectional shape. For example, tubes may have a cross-sectional shape that is not circular. Accordingly, the tubes of a tubular reactor may, in one or more embodiments, have a circular, elliptical, rectangular, and/or other cross sectional shape(s).

As used herein and as mentioned above, the abbreviation “WGSR” stands for water-gas-shift reaction, while “WGS” stands for water-gas-shift.

### DETAILED DESCRIPTION

In one or more embodiments of the embodiments of the disclosure, recycling CO₂ recovered from production of an FT reactor appears to have no deleterious effects on the FT process. If a steam methane reformer (“SMR”) is used to produce the syngas, it would ordinarily produce a higher ratio of hydrogen with respect to carbon monoxide than needed in the feed for the FT reactor. In one or more embodiments of the embodiments of the disclosure, a portion of the CO₂ recycled to the SMR is converted to carbon monoxide, mitigating the need to adjust the hydrogen level. While the phenomena of conversion of carbon dioxide to carbon monoxide has been used with methanol plants, it is not believed to have been implemented in an FT process in conjunction with recycling recovered CO₂. In addition, it appears that having a higher ratio of CO₂ in the syngas mixture used as a feed to the FT reactor improves the heat transfer properties of the feed gas and thus the performance of the FT reactor.

Laboratory test results made with respect to an FT system in accordance with the present disclosure indicate that carbon dioxide in the feed gas to the FT reactor at levels around 12-25% or more may improve performance of the FT reactor, using a LTHP (low temperature, high pressure) FT reactor having a cobalt-based, alumina-supported FT catalyst, such as TL8™ or TL8H™ available from Emerging Fuels Technologies, Inc. (“EFT”) or FT Co Premier™ available from Cosmas Inc. Pilot plant operations have confirmed that an advantage to the presence of carbon dioxide at levels around 12-25% or more in the synthesis gas feed to the FT Reactor. From pilot plant tests, it does not appear that any noticeable amount of CO2 acts as a reactant in the FT reactor. Instead, while not being bound by theory, it is surmised that the high carbon dioxide concentration significantly improves the heat transfer properties of the syngas in the FT reactor. Preferably, the feedstock for a syngas preparation unit to make syngas comprises natural gas, although other carbonaceous feedstocks may also be used. The feed gas to the FT reactor would comprise carbon dioxide and syngas, with the syngas preferably having a low H₂:CO ratio, such as in a range of 1.4:1 to 1.8:1 and preferably approximately 1.6:1.

When steam methane reforming is used to produce syngas from natural gas for FT synthesis, CO₂ will typically be present in the raw syngas in concentrations up to 10 vol. % on a dry basis. A smaller volume of CO₂ may also be captured from an FT tail gas and/or an FT purge stream taken from an FT tail gas by one or more means, such as an amine CO₂ removal system or similar absorbent. Alternatively, carbon dioxide may be supplied from outside the FT plant.

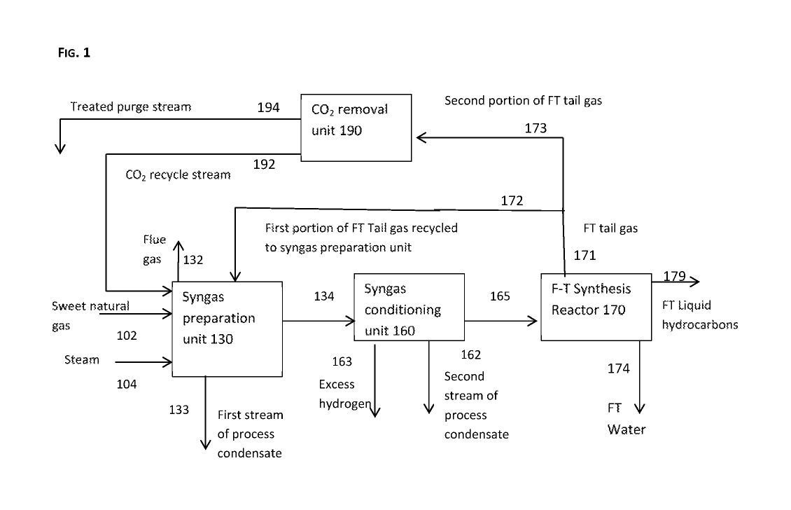

FIG. 1 depicts a simplified flow diagram for a Fischer Tropsch system in accordance with one or more embodiments of the present disclosure, which include recycling carbon dioxide and, optionally, a first portion of an FT tail gas to a syngas preparation unit 130. Natural gas and steam feed into the syngas preparation unit 130, from a natural gas line 102 and a steam line 104, respectively. The natural gas entering the syngas preparation unit 130 is preferably sweet natural gas, from which any excess sulfur or sulfur compounds such as H₂S has been previously removed. The syngas preparation unit 130 also includes as an input a carbon dioxide (CO₂) recycle stream, as discussed further herein. The syngas preparation unit 130 may also include as an input an FT tail gas recycle stream, as discussed further herein. The syngas preparation unit 130 may be any syngas preparation unit, such as without limitation a steam methane reformer, an autothermal reformer, a hybrid reformer, or a partial oxidation reformer, each of which might require slightly different configurations, inputs, operating conditions and reformer catalysts, as is known in the art. However, use of a steam methane reformer may be particularly beneficial, through facilitation of a reverse shift reaction, as described more fully below with respect to Equation 4. Providing a higher level of CO₂ in the feed to the steam methane reformer suppresses the formation in the steam methane reformer of undesirable excess hydrogen by facilitating the reverse shift reaction:

CO₂+H₂⇄CO+H₂O. (4)

Carbon dioxide combines with hydrogen in the steam methane reformer, converting to carbon monoxide and water, thus resulting in a lower ratio of hydrogen to carbon monoxide in the resulting syngas than would be produced without the additional carbon dioxide. Accordingly, provision of additional CO₂ to a steam methane reformer, for example through recycling of CO₂, may be beneficial to the overall FT process, as more carbon monoxide is produced and less hydrogen has to be removed. In addition or in the alternative, carbon dioxide from other sources (not depicted in FIG. 1) may be added as a feed to the syngas preparation unit 130 to increase the percentage of carbon dioxide in the feed to the steam methane reformer.

In FIG. 1, the configuration depicted for the syngas preparation unit 130 is appropriate for a steam methane reformer having an appropriate reformer catalyst. A flue gas stream exits the syngas preparation unit 130 via a flue gas flowline 132. A first stream of process condensate exits the syngas preparation unit 130 via a first process condensate flowline 133. The syngas preparation unit 130 will produce a mixture of syngas and CO₂, which passes via a first syngas flowline 134 to a syngas conditioning unit 160. A second stream of process condensate is collected in a second process condensate flowline 162 from the syngas conditioning unit 160. The syngas conditioning unit 160 adjusts the hydrogen and carbon monoxide ratios in the syngas of the mixture to pre-determined levels, if needed, to create a conditioned mixture, which includes conditioned syngas and CO₂. For example, excess hydrogen could be removed from the syngas, for example via a membrane with hydrogen exiting the syngas conditioning unit 160 through a hydrogen flowline 163. Preferably, the H₂:CO ratio of the conditioned syngas is low, such as approximately in a range of 1.4:1 to 1.8:1 and more preferably 1.6:1.

Continuing to refer to FIG. 1, the conditioned mixture is sent via a second syngas flowline 165 to an FT synthesis reactor 170 for processing into FT hydrocarbons. The FT synthesis reactor 170 may be, for example, a fixed bed, tubular, LTHP FT reactor and preferably uses a cobalt-based, alumina-supported catalyst, such as TL8™ or TL8H™, both available from Emerging Fuels Technologies, Inc. (“EFT”), or FT Co Premier, available from Cosmas Inc. In accordance with the present disclosure, the conditioned mixture used as a feed to the FT synthesis reactor 170 may contain substantial amounts of carbon dioxide, such as 12-25 vol % or even greater. In embodiments, the conditioned syngas mixture used as a feed to the FT synthesis reactor 170 contains about at least 10 vol % of carbon dioxide. In embodiments, the conditioned syngas mixture used as a feed to the FT synthesis reactor 170 contains about at least 12 vol % of carbon dioxide. In embodiments, the conditioned syngas mixture used as a feed to the FT reactor 170 contains about at least 15 vol % of carbon dioxide. In embodiments, the conditioned syngas mixture used as a feed to the FT synthesis reactor 170 contains about at least 20 vol % of carbon dioxide. In embodiments, the conditioned syngas mixture used as a feed to the FT synthesis reactor 170 contains about at least 25 vol % of carbon dioxide.

The FT reactor 170 is preferably a low temperature, low pressure fixed bed, tubular FT reactor and may comprise two or more reactor vessels operating in parallel. The tube velocity used in the FT reactor is in a range of approximately 0.3 ft/sec to 1.5 ft/sec and preferably approximately 0.5 ft/sec. In other embodiments, the FT reactor may be a slurry FT reactor or a bubble-column FT reactor or a compact FT reactor.

Although not depicted in FIG. 1, the conditioned syngas mixture may be preheated to a temperature in the range of approximately 300 to 400° F. before being fed to the FT reactor. In embodiments, the conditioned syngas mixture may be preheated to a temperature in the range of approximately 320 to 380° F. before being fed to the FT reactor. In embodiments, the conditioned syngas mixture may be preheated to a temperature in the range of approximately 340 to 360° F. before being fed to the FT reactor. The inlet pressure of the conditioned syngas mixture may be in the range of approximately 400 psia to approximately 500 psia. In embodiments, the inlet pressure of the conditioned syngas mixture may be in the range of approximately 420 psia to approximately 480 psia. In embodiments, the inlet pressure of the conditioned syngas mixture may be in the range of approximately 440 psia to approximately 460 psia.

Referring again to FIG. 1, products of the FT reactor 170 include an FT tail gas, an FT water stream, and liquid FT hydrocarbons. The FT water stream exits the FT reactor 170 via an FT water line 174. The liquid FT hydrocarbons exit the FT reactor 170 via an FT product flowline 179. The FT tail gas exits the FT reactor 170 via a first FT tail gas flowline 171. Optionally, and as described in co-pending patent application PCT Patent Application No. PCT/US2015/033233, in one or more embodiments of the present disclosure, at least a first portion of the FT tail gas is sent via a second FT tail gas flowline 172 as an additional input to the syngas preparation unit 130. In other embodiments, FT gas may not be recycled or may be recycled in some other way.

In the embodiments of FIG. 1, a third FT tailgas flowline 173 carries least a second portion of the FT tail gas to a CO₂ removal unit 190, where the second portion of the FT tail gas maybe split into at least a CO₂ recycle stream and a treated purge gas stream, carried by a CO₂ recycling flowline 192 and a treated purge gas flowline 194, respectively. The purge gas stream may contain hydrogen. The purge gas stream may be used for fuel for the syngas preparation unit 130 or for other plant purposes. In one or more preferred embodiments of the disclosure, all or a substantial portion of the CO₂ recycle stream is recycled via the CO₂ recycling flowline 192 as an input to the syngas preparation unit 130, either separately or together with the first portion of the FT tail gas and/or the natural gas stream. In one or more embodiments, a portion of the CO₂ recycle stream may be sent as a feed to the FT reactor 170. In one or more embodiments, the CO₂ recycle stream may be sent as a feed to the FT reactor 170.

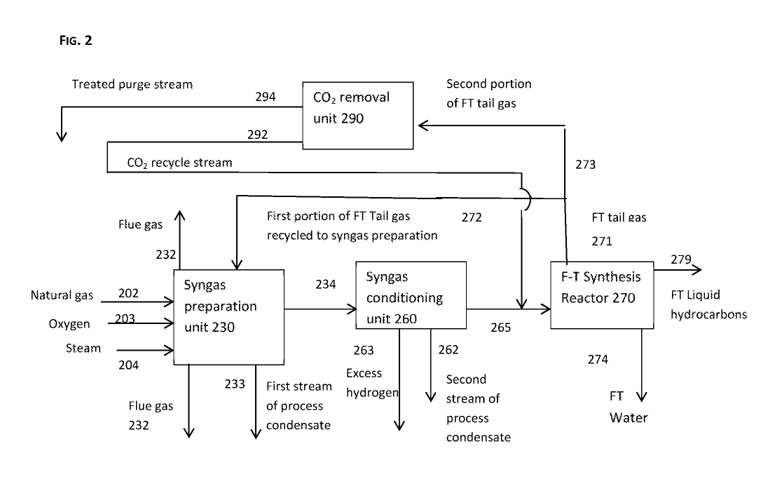

FIG. 2 depicts a simplified flow diagram for a Fischer Tropsch system in accordance with one or more embodiments of the present disclosure, wherein a first portion of an FT tail gas is recycled to a syngas preparation unit, a second portion of the FT tail gas is treated for utilization and carbon dioxide is recycled as a feed to an FT reactor. Natural gas, oxygen and steam enter a syngas preparation unit 230, via a natural gas feed line 202, an oxygen feed line 203 and a steam line 204 respectively The natural gas entering the syngas preparation unit 230 is preferably sweet natural gas, from which any excess sulfur or sulfur compounds such as H₂S has been previously removed. In various embodiments, the syngas preparation unit 230 may comprise any syngas preparation unit, such as a steam methane reformer, an autothermal reformer, a hybrid reformer, or a partial oxidation reformer. With the oxygen feed line 203, the embodiments of FIG. 2 are suitable for the syngas preparation unit 230 to comprise an autothermal reformer (ATR).

A flue gas and a syngas exit the syngas preparation unit 230 via a flue gas flowline 232 and a first syngas flowline 234, respectively. A first stream of process condensate exits the syngas preparation unit 230 via a first process condensate flowline 233. Unlike a steam methane reformer, an ATR does not produce syngas with a high hydrogen to carbon monoxide ratio, so there may be little if any excess hydrogen to be removed. However, if an adjustment of the hydrogen to carbon monoxide ratio is to be made, the syngas passes via the first syngas flowline 234 to a syngas conditioning unit 260. In the embodiments depicted in FIG. 2, the syngas conditioning unit 260 removes excess hydrogen from the syngas. The excess hydrogen, if any, exits the syngas conditioning unit 260 and may be sent to other parts of the plant via a hydrogen flowline 263. The syngas conditioning unit 260 also removes a second stream of process condensate is collected in a second process condensate flowline 262. Removal of the excess hydrogen, if any, and the second stream of condensate results in a conditioned syngas. Preferably, the H₂:CO ratio of the conditioned syngas is low, such as approximately 1.6 to 1.

Referring again to FIG. 2, conditioned syngas is sent via a second syngas flowline 265 to an FT reactor 270 for processing. The FT reactor 270 preferably uses a cobalt-based, alumina-supported catalyst, such as TL8™ or TL8H™, both available from Emerging Fuels Technologies, Inc. (“EFT”), or FT Co Premier, available from Cosmas Inc. In accordance with the present disclosure, the conditioned syngas used as a feed to the FT reactor 270 may contain substantial amounts of carbon dioxide, such as 12-25 vol. % or even greater, provided by a carbon dioxide recycle flowline 292 and/or from additional sources not depicted in FIG. 2. In embodiments, the feed to the FT reactor 270 contains about at least 10 vol % of carbon dioxide. In embodiments, the feed to the FT reactor 270 contains about at least 12 vol % of carbon dioxide. In embodiments, the feed to the FT reactor 270 contains about at least 15 vol % of carbon dioxide. In embodiments, the feed to the FT reactor 270 contains about at least 20 vol % of carbon dioxide. In embodiments, the feed to the FT reactor 270 contains about at least 25 vol % of carbon dioxide.

The FT reactor 270 is preferably a low temperature, high pressure, fixed bed, tubular FT reactor and may comprise two or more reactor vessels operating in parallel. The tube velocity used in the FT reactor is in a range of approximately 0.3 ft/sec to 1.5 ft/sec and preferably approximately 0.5 ft/sec. In other embodiments, the FT reactor 270 may comprise a slurry FT reactor or a bubble-column FT reactor or a compact FT reactor.

Although not depicted in FIG. 2, the conditioned syngas mixture may be preheated to a temperature in the range of approximately 300 to 400° F. before being fed to the FT reactor 270. In embodiments, the conditioned syngas mixture may be preheated to a temperature in the range of approximately 320 to 380° F. before being fed to the FT reactor. In embodiments, the conditioned syngas mixture may be preheated to a temperature in the range of approximately 340 to 360° F. before being fed to the FT reactor. The inlet pressure of the conditioned syngas mixture may be in the range of approximately 400 psia to approximately 500 psia. In embodiments, the inlet pressure of the conditioned syngas mixture may be in the range of approximately 420 psia to approximately 480 psia. In embodiments, the inlet pressure of the conditioned syngas mixture may be in the range of approximately 440 psia to approximately 460 psia.

Continuing to refer to FIG. 2, products of the FT reactor 270 include an FT tail gas stream, an FT water stream, and an FT liquid hydrocarbon stream. The FT tail gas stream exits the FT reactor via a first FT tail gas flowline 271. The FT water stream and an FT liquid hydrocarbon stream exit the FT reactor 270 via an FT water line 274 and an FT product line 279, respectively. Optionally, and as described in co-pending patent application PCT Patent Application No. PCT/US2015/033233 and as depicted in FIG. 2, at least a first portion of the FT tail gas stream is sent via a second FT tail gas flowline 272 as an additional feed to the syngas preparation unit 230. Alternatively, the first portion of the FT tail gas stream may be combined with the sweet natural gas upstream of the syngas preparation unit 230 to be used as a feed to the syngas preparation unit 230 or may be disposed of in some other way. A third FT tailgas flowline 273 carries least a second portion of the FT tail gas stream to a CO₂ removal unit 290, where the second portion of the FT tail gas stream can be split into at least a CO₂ recycle stream and a treated purge gas stream, carried by the CO₂ recycling flowline 292 and a treated purge gas flowline 294, respectively. The purge gas stream may contain hydrogen and may be used for fuel for the syngas preparation unit 2 or for other plant purposes. As depicted in FIG. 2, the CO₂ recycle stream may be used as a feed for the FT reactor 270. The CO₂ recycle stream may be combined with the conditioned reformed gas as a feed to the FT reactor 270 or may be used as a separate feed to the FT reactor 270. In addition or in the alternative, carbon dioxide from other sources (not depicted in FIG. 2) may be added as a feed to the syngas preparation unit 230. In alternate embodiments, at least a portion of the CO₂ recycle stream may be sent as a feed to the syngas preparation unit.

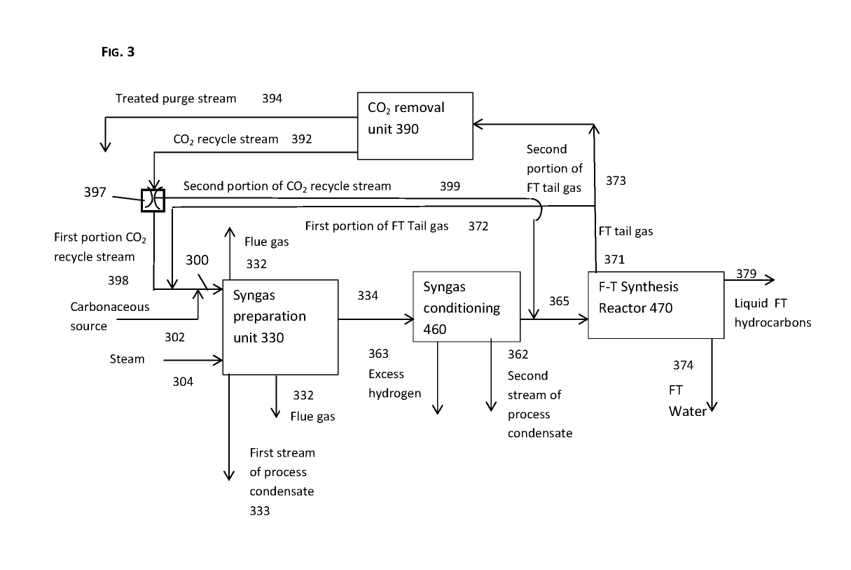

FIG. 3 depicts a simplified flow diagram for a Fischer Tropsch system in accordance with one or more embodiments of the present disclosure, wherein a first portion of an FT tail gas is recycled to a syngas preparation unit, a second portion of the FT tail gas and of a FT purge stream are treated for utilization, and carbon dioxide is recycled both as a feed to an FT reactor and as a feed to a syngas preparation unit. A carbonaceous source and steam enter a syngas preparation unit 330, from a carbonaceous feed line 302 and a steam line 304, respectively. Specifically, in FIG. 3, the carbonaceous feed line 302 is fluidly connected to a mixed gas feed line 300; the carbonaceous source enters the syngas preparation unit 330 as part of a mixed gas feed through the mixed gas feed line 300. The carbonaceous source is preferably sweet natural gas, from which any excess sulfur or sulfur compounds such as H₂5 have been previously removed. In alternate embodiments, the carbonaceous source may be alternate sources of carbon that has been converted to gas through gasification. Other components of the mixed gas feed may include recycled FT tail gas, and a first potion of a carbon dioxide recycle stream, as discussed further below.

The syngas preparation unit 330, preferably a steam methane reformer, converts the carbonaceous source into a syngas, which is a component of a gas mixture, which also contains CO₂. A flue gas exits the syngas preparation unit 330 via a flue gas flowline 332. The produced gas mixture exits the syngas preparation unit 330 via a first mixed flowline 334. A first stream of process condensate 333 exits the syngas preparation unit 330 via a first process condensate flowline. The gas mixture passes to a syngas conditioning unit 360. The syngas conditioning unit 360 removes from the syngas a second stream of process condensate, which exits the syngas conditioning unit 360 via a second process condensate flowline 362. The syngas conditioning unit 360 adjusts the hydrogen and carbon monoxide ratios in the syngas of the gas mixture to pre-determined levels, if needed, to form a conditioned gas mixture. Excess hydrogen may be carried from the syngas conditioning unit 360 in hydrogen flowline 363. Preferably, the H₂:CO ratio of the conditioned syngas is sub-stoichiometric, that is below 2 to 1, preferably in the range of approximately 1.4:1 to approximately 1.8:1 and more preferably approximately 1.6 to 1.

The conditioned gas mixture is sent via a third flowline 365 to an FT reactor 370 as a feed. A second portion of the carbon dioxide recycle stream is optionally added to the conditioned gas mixture upstream of the FT reactor 370, as part of the FT reactor feed. The FT reactor 370 preferably uses a cobalt-based, alumina-supported catalyst, such a TL8™ or TL8H™, both available from Emerging Fuels Technologies, Inc. (“EFT”) or FT Co Premier available from Cosmas, as the FT catalyst. In accordance with the present disclosure, the FT reactor feed to the FT reactor 370 may contain substantial amounts of carbon dioxide, such as 12-25% or greater. In embodiments, the FT reactor feed contains about at least 10 vol % of carbon dioxide. In embodiments, the FT reactor feed contains about at least 12 vol % of carbon dioxide. In embodiments, the FT reactor feed contains about at least 15 vol % of carbon dioxide. In embodiments, the FT reactor feed contains about at least 20 vol % of carbon dioxide. In embodiments, FT reactor feed contains about at least 25 vol % of carbon dioxide.

The FT reactor 370 is preferably a low temperature, high pressure, fixed bed, tubular FT reactor and may comprise two or more reactor vessels operating in parallel. The tube velocity used in the FT reactor 370 is in a range of approximately 0.3 ft/sec to 1.5 ft/sec and preferably approximately 0.5 ft/sec. In other embodiments, the FT reactor 370 may comprise a slurry FT reactor or a bubble-column FT reactor or a compact FT reactor. Although not depicted in FIG. 3, the FT reactor feed may be preheated to a temperature in the range of approximately 300 to 360° F. before being fed to the FT reactor 370. In embodiments, the FT reactor feed may be preheated to a temperature in the range of approximately 320 to 380° F. before being fed to the FT reactor 370. In embodiments, the FT reactor feed may be preheated to a temperature in the range of approximately 340 to 360° F. before being fed to the FT reactor 370. The inlet pressure of the FT reactor may be in the range of approximately 400 psia to approximately 500 psia.

The inlet pressure of the FT reactor 370 may be in the range of approximately 400 psia to approximately 500 psia. In embodiments, the inlet pressure of the FT reactor 370 may be in the range of approximately 420 psia to approximately 480 psia. In embodiments, the inlet pressure of the FT reactor 370 may be in the range of approximately 440 psia to approximately 460 psia.

Fluids produced by the FT reactor 370 include an FT tail gas stream, an FT water stream, and liquid FT hydrocarbon stream. The FT tail gas exits the FT reactor 370 via a first FT tail gas flowline 371. The liquid FT hydrocarbon stream exits the FT reactor 370 via an FT products flowline 379, to storage and/or additional processing. The FT water stream exits the FT reactor 370 via an FT water flowline 374. As described in co-pending PCT Patent Application No. PCT/US2015/033233, optionally, a first portion of the FT tail gas is recycled as a feed to the syngas preparation unit 330 via a second FT tail gas flowline 372.

A second portion of the FT tail gas is sent via a third FT tail gas flowline 373 to a carbon dioxide removal unit 390, which removes carbon dioxide from the second portion of the FT tail gas. The removed carbon dioxide forms a carbon dioxide recycle stream, which exits the carbon dioxide removal unit 390 via a first carbon dioxide recycle line 392. The carbon dioxide removal unit 390 also produces a treated purge steam gas. The treated purge steam gas may contain hydrogen. The treated purge steam gas exits the carbon dioxide removal unit 390 via a treated purge gas line 394 and may be used for fuel for the syngas preparation unit 330 or for other plant purposes.

In accordance with the present disclosure, as depicted in FIG. 3, the CO₂ recycle stream is split, such as, for example without limitation, with a flow splitter device 397, into a first portion of the CO₂ recycle stream and a second portion 399 of the CO₂ recycle stream. The flow splitter device 397 may be for example, but without limitation, a splitter, a flow valve or a diverter valve and may be operated and/or controlled in various ways as known by those of skill in the art. The first portion of the CO₂ recycle stream is recycled as an input to the syngas preparation unit 330 via a second carbon dioxide recycle line 398, thus increasing the percentage of carbon dioxide present in the produced gas mixture. The first portion of the CO₂ recycle stream may be recycled as an input to the syngas preparation unit 330 either separately or, as depicted in FIG. 3, together with the first portion of the FT tail gas and the carbonaceous source, as components of the mixed gas feed. The second portion of the CO₂ recycle stream is sent via a third carbon dioxide recycle line 399 to a point upstream of the FT reactor 370 and downstream of the syngas conditioning unit 360, where the second portion of the CO₂ recycle stream is combined with the conditioned gas mixture as the feed to the FT reactor 370.

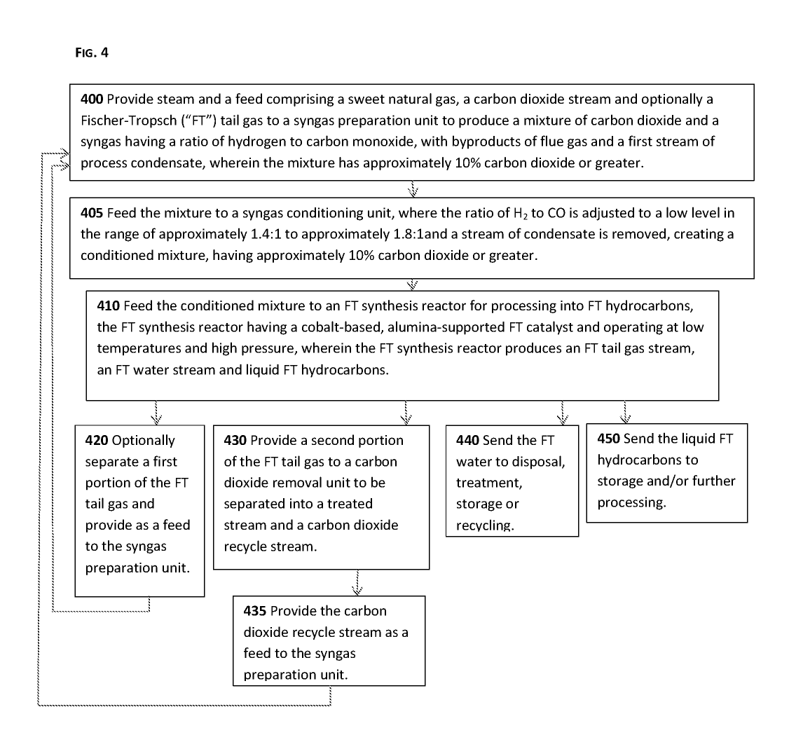

FIG. 4 depicts a flowchart in accordance with one or more embodiments of the present disclosure. In which carbon dioxide is recycled to a syngas preparation unit. In step 400, steam and a feed comprising a sweet natural gas and a carbon dioxide stream are provided as a feed to a syngas preparation unit, preferably a steam methane reformer, to produce a mixture of carbon dioxide and a syngas having a ratio of hydrogen to carbon monoxide. The mixture has approximately 10 vol % carbon dioxide or greater. The syngas preparation unit also produces byproducts of flue gas and a first stream of process condensate. Optionally, a portion of an FT tail gas stream may also be part of the feed for the syngas preparation unit. In step 405, the mixture is fed to a syngas conditioning unit, where the ratio of hydrogen to carbon monoxide is adjusted to a low level in the range of approximately 1.4:1 to approximately 1.8:1 and a stream of condensate is removed, creating a conditioned mixture.

Continuing to refer to FIG. 4, in step 410, the conditioned mixture is fed to an FT synthesis reactor for processing into FT hydrocarbons, the FT synthesis reactor having a cobalt-based, alumina-supported FT catalyst and operating at low temperatures and high pressure. The FT synthesis reactor produces an FT tail gas stream, an FT water stream and liquid FT hydrocarbons. In step 420, a first portion of the FT tail gas may optionally be separated from the FT tail gas stream and sent as a feed to the syngas preparation unit. In step 430, a second potion of the FT tail gas is provided to a carbon dioxide removal unit to be separated into a treated stream and a carbon dioxide recycle stream. In step 435, the carbon dioxide recycle stream is provided as a feed to the syngas preparation unit. The FT water stream is sent to disposal, treatment, storage, or recycling in step 440. In step 450, the liquid FT hydrocarbons are sent to storage or further processing.

While some preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims that follow, that scope including all equivalents of the subject matter of the claims. Each and every claim is incorporated into the specification as an embodiment of the present invention. Thus, the claims are a further description and are an addition to the preferred embodiments of the present invention. The inclusion or discussion of a reference is not an admission that it is prior art to the present invention, especially any reference that may have a publication date after the priority date of this application. The disclosures of all patents, patent applications, and publications cited herein are hereby incorporated by reference, to the extent that they provide background knowledge; or exemplary, procedural or other details supplementary to those set forth herein.

What is claimed is:

1. A method of producing Fischer-Tropsch (“FT”) hydrocarbons via FT synthesis in an FT reactor, the method comprising:
a) producing a liquid FT hydrocarbon stream, an FT tail gas stream and an FT water stream using an FT reactor feed in the FT reactor under low temperature, high pressure FT operating conditions, the FT reactor feed comprising a mixture of carbon dioxide and syngas, the syngas having a low H₂:CO ratio in the range of approximately 1.4:1 to approximately 1.8:1, and, the FT reactor feed having a level of carbon dioxide at least as high as about 10 volume % and the FT reactor having a cobalt-based, alumina-supported FT catalyst.

2. The method of claim 1, further comprising:
b) sending a first portion of the FT tail gas stream to a carbon dioxide recovery unit;
c) using the carbon dioxide recovery unit to recover a carbon dioxide stream from the first portion of the FT tail gas; and
d) recycling the carbon dioxide stream upstream of the FT reactor.

3. The method of claim 2, wherein at least a portion of the carbon dioxide stream is recycled as a feed to the FT reactor.

4. The method of claim 2, wherein at least a first portion of the carbon dioxide stream is recycled upstream of a syngas preparation unit used to produce syngas.

5. The method of claim 4, wherein the syngas preparation unit is a steam methane reformer.

6. The method of claim 5, further comprising treating the syngas produced by the steam methane reformer upstream of the FT reactor to achieve the low H₂:CO ratio.

7. The method of claim 4, further comprising adding carbon dioxide from an external supply source as part of the feed to the syngas preparation unit.

8. The method of claim 2, further comprising recovering a treated stream containing hydrogen from the carbon dioxide removal unit.

9. The method of claim 2, wherein the level of carbon dioxide in the FT reactor feed is at least 15%.

10. The method of claim 2, wherein the level of carbon dioxide in the FT reactor feed is at least 25%.

11. The method of claim 2, wherein the level of carbon dioxide in the FT reactor feed is at least 25%.

12. The method of claim 2, wherein the FT reactor is a LTHP fixed bed, tubular reactor and further comprising operating the FT reactor at a tube velocity in a range of approximately 0.4 ft/sec to approximately 0.6 ft/sec.

13. The method of claim 12, wherein the low temperature, high pressure FT operating conditions are within a temperature range of approximately 320° F. to approximately 400° F. and a pressure range of approximately 400 psia to approximately 500 psia.

14. The method of claim 12, wherein the low temperature, high pressure FT operating conditions are within a temperature range of approximately 340° F. to approximately 360° F. and a pressure range of approximately 440 psia to approximately 480 psia.

15. The method of claim 12, wherein the low H₂:CO ratio is approximately 1.6:1.

16. The method of claim 12, wherein the tube velocity is approximately 0.5 ft/sec.

17. The method of claim 14, wherein the low H₂:CO ratio is approximately 1.6:1, wherein at least a first portion of the carbon dioxide stream is recycled upstream of a syngas preparation unit used to produce syngas. wherein the syngas preparation unit is a steam methane reformer and wherein the syngas produced by the steam methane reformer undergoes treatment upstream of the FT reactor to achieve the low H₂:CO ratio and further comprising operating the FT reactor at a tube velocity of approximately 0.5 ft/sec.

18. A system for producing Fischer Tropsch (“FT”) hydrocarbons, the system comprising:
a) a syngas preparation unit for using a sweet natural gas, a stream of steam and a stream of carbon dioxide gas as inputs to produce a mixture of carbon dioxide and a syngas, the syngas comprising hydrogen and carbon monoxide, having an initial H₂:CO ratio;
b) a LTHP FT reactor, fluidly connected to the syngas preparation unit, having an FT synthesis catalyst comprising a cobalt-based, alumina supported FT catalyst, configured to use as an FT reactor feed a mixture of syngas, having a low H₂:CO ratio in the range of approximately 1.4:1 to approximately 1.8:1, and carbon dioxide, the mixture having a carbon dioxide level of at least about 10 volume %, the FT reactor configured to use the FT reactor feed to make, under FT operating conditions, liquid FT hydrocarbons.

19. The system of claim 18, further comprising:
c) a carbon dioxide recovery unit to recover a carbon dioxide stream from an input stream;
d) a flowline for conveying a first portion of the FT tail gas as a feed to the carbon dioxide recovery unit; and
e) a second flowline to convey at least a portion of the recovered carbon dioxide stream as a feed to the syngas preparation unit.

20. The system of claim 19, wherein the LTHP FT reactor is a fixed bed, tubular reactor.

21. The system of claim 20, wherein the LTHP FT reactor is operable at a tube velocity in a range of approximately 0.4 ft/sec to approximately 0.6 ft/sec.

22. The system of claim 19, wherein the syngas preparation unit comprises a steam methane reformer and further comprising:
f) a syngas conditioning unit, having a feed input fluidly connected to an output of the syngas preparation unit, to condition the mixture to remove a process condensate stream and produce a conditioned mixture, the syngas component of the mixture having the low H₂:CO ratio, the output of the syngas conditioning unit being fluidly connected to a feed input of the FT reactor.

23. The system of claim 18, wherein the syngas preparation unit is a partial oxidation reactor.

24. The system of claim 18, wherein the syngas preparation unit is an autothermal reformer.

25. The system of claim 18, further comprising an external supply source to supply carbon dioxide as a feed to the syngas preparation unit.

26. The system of claim 21, wherein the syngas of the FT reactor feed has a low H₂:CO ratio of approximately 1.6:1

27. The system of claim 18, wherein the level of carbon dioxide in the FT reactor feed is over 15 volume percent.

28. The system of claim 18, wherein the level of carbon dioxide in the FT reactor feed is over 20 volume percent.

29. The system of claim 18, wherein the level of carbon dioxide in the FT reactor feed is at least 25 volume percent.

30. The system of claim 21, wherein operating conditions for the LTHP FT reactor are within a temperature range of approximately 320° F. to approximately 400° F. and a pressure range of approximately 400 psia to approximately 500 psia.

31. The system of claim 21, wherein operating conditions for the LTHP FT reactor are within a temperature range of approximately 340° F. to approximately 360° F. and a pressure range of approximately 440 psia to approximately 480 psia.

32. The system of claim 22, wherein the low H₂:CO ratio is about 1.6:1.

33. An apparatus for producing Fischer Tropsch (“FT”) hydrocarbons, the apparatus comprising:
a) a LTHP FT reactor having an FT synthesis catalyst comprising a cobalt-based, alumina-supported FT catalyst, configured to use an FT reactor feed comprising a mixture of carbon dioxide and syngas, the syngas having a low H₂:CO ratio in the range of approximately 1.4:1 to approximately 1.8:1, the FT reactor feed having a carbon dioxide level of at least about 12 volume %, to make, under FT operating conditions liquid FT hydrocarbons, FT tail gas and FT water.

34. The apparatus of claim 33, wherein the LTHP FT reactor is a fixed bed, tubular reactor, operable at a tube velocity in a range of approximately 0.4 ft/sec to approximately 0.6 ft/sec.

35. The apparatus of claim 33, wherein the level of carbon dioxide in the conditioned mixture is over 15 volume %.

36. The apparatus of claim 33, wherein the level of carbon dioxide in the conditioned mixture is over 20 volume %.

37. The apparatus of claim 34, wherein operating conditions for the LTHP FT reactor are within a temperature range of approximately 340° F. to approximately 360° F. and a pressure range of approximately 440 psia to approximately 480 psia and wherein the low H₂:CO ratio is about 1.6:1.

38. The apparatus of claim 35, wherein at least a portion of the carbon dioxide in thee FT reactor feed comprises carbon dioxide recovered from the FT tail gas and recycled upstream of the FT reactor.
